(19) United States
(12) Patent Application Publication
(10) Pub. No.: US 2015/0134804 A1
(43) Pub. Date: May 14, 2015

(54) COMMUNICATION DEVICE AND COMMUNICATION SYSTEM

(71) Applicant: Riko Yagiu, Tokyo (JP)

(72) Inventor: Riko Yagiu, Tokyo (JP)

(73) Assignee: Mitsubishi Electric Corporation, Tokyo (JP)

(21) Appl. No.: 14/399,247

(22) PCT Filed: May 17, 2012
(86) PCT No.: PCT/JP2012/062676

§ 371 Date: Nov. 6, 2014

(51) Int. Cl. H04L 29/12

(52) U.S. Cl. CPC H04L 61/2046; H04L 61/2007
USPC 709/223

(57) ABSTRACT

A communication device including a plurality of network interfaces includes: an interface management table representing a priority of each network interface, an address assignment protocol to be used in IP address assignment to each network interface, and an IP address assignment status with respect to each network interface; a protocol management table managing a priority of an address assignment protocol to be used in IP address assignment; and an address management unit performing a process of determining availability/unavailability of an IP address, a process of determining necessity of an IP-address reassignment operation, and a process of determining an IP address to be released when it is determined that an IP-address reassignment operation is required, based on the interface management table and the protocol management table, when an IP address is assigned to any one of the network interfaces from an address assignment device.

### FIELD

The present invention relates to a communication device including a plurality of network interfaces, and more particularly to a communication device and a communication system that can be connected to a plurality of networks by assigning an IP address individually to each of a plurality of network interfaces.

### BACKGROUND

Conventionally, in a device (a communication device or the like) to which an IP address is assigned from an external device, an IP address which has been selected from an assignable range by the external device (a device that assigns an IP address) and of which the device has been notified is set. The device to which an IP address is assigned generally does not know IP addresses assigned to other devices to which IP addresses are assigned. Therefore, even if the device is notified of an IP address already assigned to another device, the device sets and uses the IP address as it is. When the same IP address is assigned to a plurality of devices, normal communication cannot be performed, which becomes a problem.

An invention for solving such a problem is disclosed in Patent Literature 1. The invention described in Patent Literature 1 is the invention of a device having a plurality of network interfaces (a printing device having a plurality of network interfaces). According to Patent Literature 1, the printing device holds a management table of IP addresses assigned to the respective network interfaces. When the printing device is notified of a candidate IP address to be assigned to a certain network interface from the outside, the printing device checks whether the IP address of which it is notified is a duplicate of an IP address already assigned to another network interface. If the IP address of which it is notified is not a duplicate of the IP address assigned to another network interface, the printing device sets the IP address. The printing device also updates the management table. On the other hand, if the IP address of which it is notified is a duplicate of the IP address of another network interface, the printing device sends a response indicating that effect to a notification source. Accordingly, such a case can be avoided where the same IP address is assigned to a plurality of network interfaces and communication cannot be performed normally.

### CITATION LIST

### Patent Literature

Patent Literature 1: Japanese Patent Application Laid-open No. 2002-342041

### SUMMARY

### Technical Problem

In a duplicate avoiding operation of an IP address according to the method described in Patent Literature 1, it is assumed that an external device that assigns an IP address has a function (a reassignment function) of re-notifying the device of a candidate IP address upon reception of a notification of occurrence of a duplicate of an IP address. Therefore, if the external device does not have the reassignment function, the duplicate of an IP address (also referred to as “address conflict”) cannot be resolved. Consequently, there is a problem in that a case where the network interface cannot be used occurs.

The present invention has been achieved in view of the above problems, and an object of the present invention is to provide a communication device and a communication system that can avoid a duplicate of an IP address, without depending on the function of an external device that assigns an IP address.

### Solution to Problem

In order to solve the above problems and achieve the object, the present invention relates to a communication device including a plurality of network interfaces to be used by assigning an IP address individually to each of the network interfaces. The communication device includes: an interface management table that represents a priority of each of the network interfaces, an address assignment protocol to be used in IP address assignment to each of the network interfaces, and an IP address assignment status with respect to each of the network interfaces; a protocol management table that manages a priority of an address assignment protocol to be used in IP address assignment; and an address management unit that performs a process of determining availability/unavailability of an assigned IP address, a process of determining a necessity of an IP-address reassignment operation, and a process of determining an IP address to be released when it is determined that an IP-address reassignment operation is required, on a basis of the interface management table and the protocol management table, when an IP address is assigned to any one of the network interfaces from an address assignment device.

### Advantageous Effects of Invention

The communication device according to the present invention manages the IP address assignment status with respect to each network interface, the priority of the network interfaces, information on the address assignment protocol to be used in the IP address assignment (including the priority), and the like in a table format. When an IP address is assigned to a certain network interface, the communication device determines whether the IP address is usable, and when it is an unusable IP address, releases the IP address assigned to a network interface having a low priority. Therefore, even when the IP address assignment is performed by using an address assignment protocol that does not have the reassignment function, if an IP address conflict occurs, the IP address conflict can be resolved. Furthermore, when an IP address that does not conflict with assigned IP addresses but is unusable is assigned, a usable IP address can be reassigned.

### BRIEF DESCRIPTION OF DRAWINGS

FIG. 1 is a diagram illustrating a configuration example of a communication system and a communication device.

FIG. 2 is a diagram illustrating an example of an interface management table.

FIG. 3 is a diagram illustrating an example of a protocol management table.

FIG. 4 is a flowchart of an example of an IP-address assignment operation.

### DESCRIPTION OF EMBODIMENTS

Exemplary embodiments of a communication device according to the present invention will be explained below in detail with reference to the drawings. The present invention is not limited to the embodiments.

### Embodiment

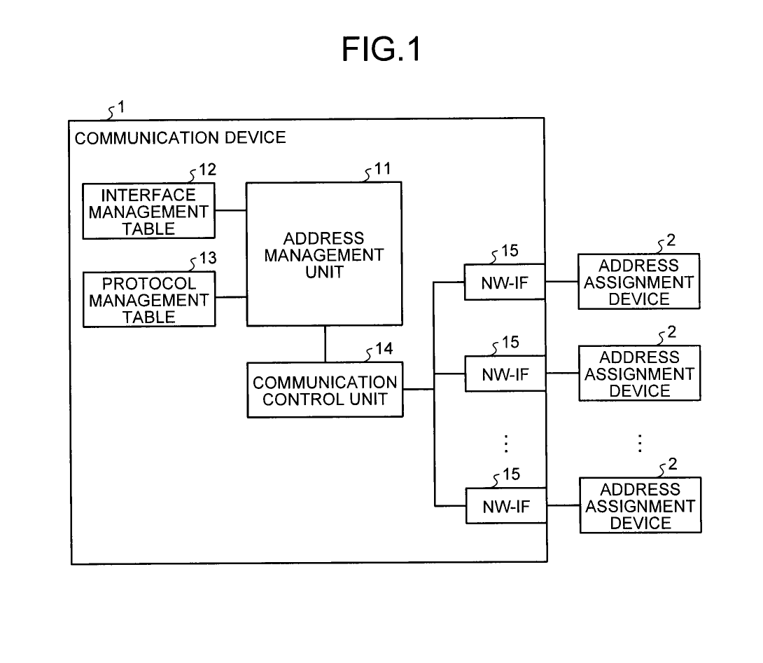

FIG. 1 is a diagram illustrating a configuration example of a communication system including a communication device according to the present invention and a configuration example of the communication device. As shown in FIG. 1, a communication device 1 includes an address management unit 11, an interface management table 12, a protocol management table 13, a communication control unit 14, and a plurality of network interfaces (NW-IF) 15. An IP address is assigned to each individual network interface 15, and the communication device 1 communicates with another communication device via the network interface 15 that has already been assigned an IP address. An address assignment device 2 that assigns an IP in response to a request from the communication device 1 is connected to each network interface 15.

In FIG. 1, a configuration example in which the network interfaces 15 and the address assignment devices 2 are connected on a one-to-one basis is shown. However, a plurality of network interfaces 15 can be connected to the common address assignment device 2. In order to avoid the description content from becoming complicated, the configuration is such that the network interfaces 15 and the address assignment devices 2 are directly connected. However, the configuration may be such that the network interfaces 15 and the address assignment devices 2 are connected via a network configured by a switch, a router, and the like.

In the communication system shown in FIG. 1, the address assignment devices 2 have a function of, for example, a PPP or DHCP server, to assign IP addresses to the network interfaces of the opposite communication device 1. When an address conflict occurs (when the same IP address is assigned to a plurality of network interfaces), for example, if the communication device 1 uses a DHCP, the communication device 1 requests reassignment of an IP address by sending a Decline message. As a result, reassignment of an IP address is performed, and the address conflict may be resolved. However, if the address assignment devices 2 do not have a mechanism of receiving a notification of the address conflict (for example, when a PPP is used), or when the implementation is such that the reassignment is performed only in the same subnet, the address conflict cannot be resolved. In such a case, the communication device 1 gives an IP address (a NULL address, a link-local address, or the like) that does not conflict with assigned IP addresses but is unusable, to an interface to which an IP address is to be assigned.

Constituent elements of the communication device 1 and an operation of the communication device 1 are explained below in detail. The characteristics of the communication device 1 are in the operation at the time when an IP address is assigned from the address assignment device 2. Therefore, in the present embodiment, parts related to the IP-address assignment operation are explained. Explanations of an operation after the IP-address assignment operation is completed (such as a communication operation to be performed by using the assigned IP address) will be omitted.

In the communication device 1, the address management unit 11 manages information on the IP address assigned to each network interface 15 in the interface management table 12. Furthermore, when the communication device 1 receives a notification of an IP address to be assigned to a certain network interface 15, the communication device 1 checks whether the IP address of which it is notified is a usable IP address. When it is not a usable IP address, reassignment of an IP address is performed. Details of the reassignment operation are explained separately.

In the interface management table 12, the IP addresses assigned to the network interfaces 15 and information related to the assignment of the IP address are registered.

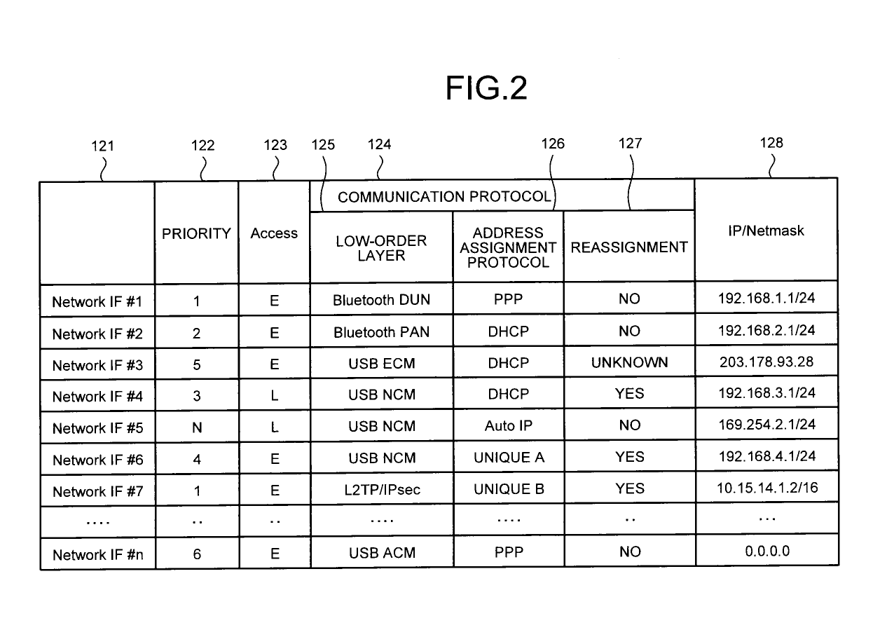

FIG. 2 is a diagram illustrating a configuration example of the interface management table 12. The interface management table 12 includes network-interface identification information 121, a network interface priority (priority) 122, an Access 123 indicating whether external access is possible, a low-order layer 125, an address assignment protocol 126, and a reassignment 127, which are information on a communication protocol 124, and an IP address (IP/Netmask) 128.

As the priority 122, any one of values from 1 to N is assigned. As the value becomes smaller, the priority becomes high. A value predetermined based on a predetermined criterion is registered in the priority 122. The same value can be set to a plurality of network interfaces. However, the priority of the network interface using the address assignment protocol of “Auto IP” is the lowest value (lowest priority). When there are a plurality of network interfaces using the address assignment protocol of “Auto IP”, the same value is set to these network interfaces.

In the case of “Access=E”, it indicates a network interface accessible to an external network (a network other than the own network). The address assignment protocol 126 in the communication protocol 124 indicates an address assignment protocol to be used for assigning an IP address to a corresponding network interface. The reassignment 127 indicates whether a corresponding address assignment protocol has a reassignment function of an IP address. When it is unknown whether the address assignment protocol has the reassignment function, “unknown” is written. When the IP-address assignment operation is performed in the “unknown” state, and as a result, it is revealed that whether the reassignment function is present, the content of the reassignment 127 is changed (changed to “Yes” or “No”). When the IP/Netmask 128 is a NULL address (0. 0. 0. 0), it indicates that the network interface is not assigned an IP address. When an IP address is assigned and it is determined that the assigned IP address is used, the IP address is registered in the IP/Netmask.

Priority information on the protocol to be used in the IP address assignment is registered in the protocol management table 13.

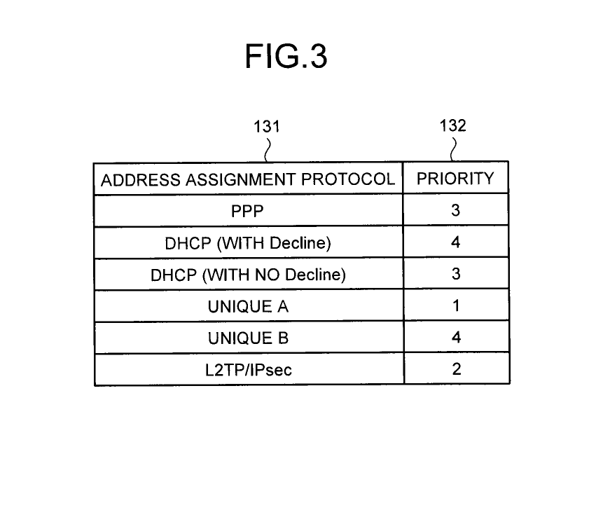

FIG. 3 is a diagram illustrating a configuration example of the protocol management table 13. A name 131 of the address assignment protocol to be used in the IP address assignment and a priority 132 of the address assignment protocol are registered in the protocol management table 13. The priority 132 is predetermined based on requirement specifications of the communication system and the like. “DHCP (with Decline)” indicates a DHCP having the reassignment function of an IP address, and “DHCP (without Decline)” indicates a DHCP that does not have the reassignment function of an IP address. The interface management table 12 and the protocol management table 13 described above can be collectively set in one table. For example, it is configured such that the priority 132 of the address assignment protocol is added to the communication protocol 124 of the interface management table 12 (see FIG. 2).

The communication control unit 14 communicates with other communication devices or the address assignment devices 2 via the network interfaces 15. When the communication control unit 14 is notified of an IP address to be assigned to the network interface 15 from the address assignment device 2, the communication control unit 14 makes an inquiry to the address management unit 11 about whether the IP address of which it is notified is usable, and when the IP address is usable, the communication control unit 14 sets the IP address of which it is notified to an IP address to be used by the network interface 15. When the IP address is not usable, the communication control unit 14 sets an IP address specified by the address management unit 11 or re-requests an IP address from the address assignment device 2, according to an instruction from the address management unit 11.

In FIG. 1, the address management unit 11 and the communication control unit 14 are separately configured. However, these units can be integrated.

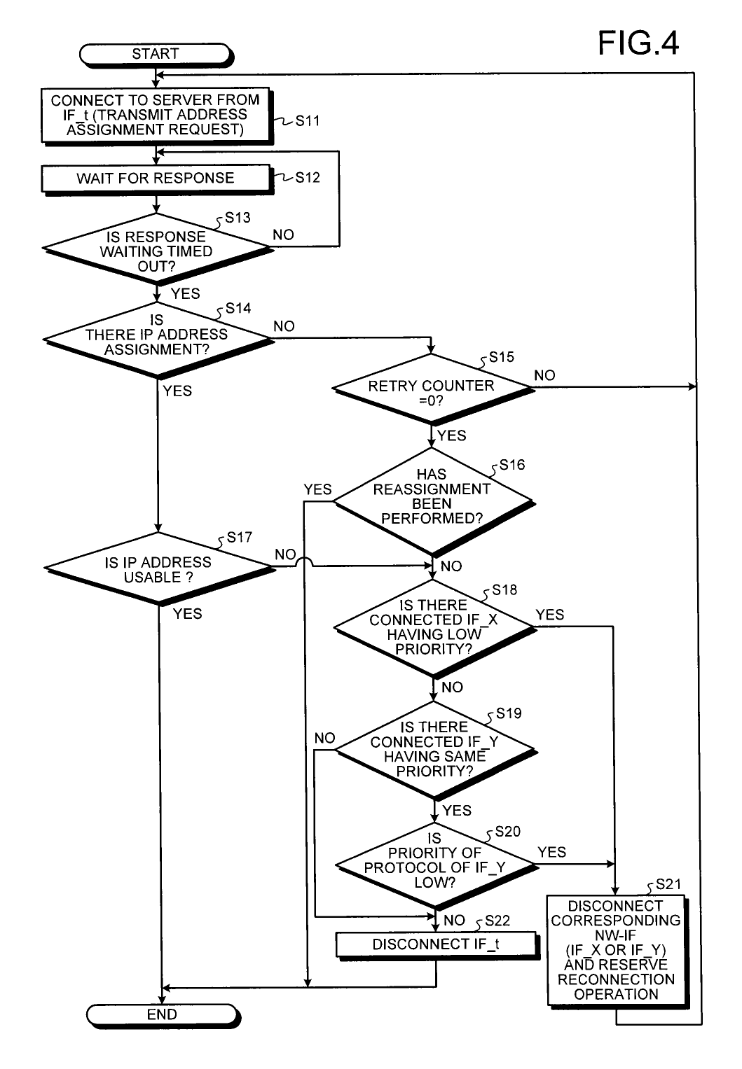

An explanation will be made of an operation example when an IP address is assigned to each network interface 15 of the communication device 1 from the address assignment device 2 connected thereto with reference to FIG. 4. FIG. 4 is a flowchart of an example of the IP-address assignment operation.

When IP address assignment to the t-th network interface IF_t is desired, the communication device 1 transmits an address assignment request to the opposite address assignment device from the network interface IF_t (Step S11). For example, when the address assignment protocol to be used is the DHCP (Dynamic Host Configuration Protocol), the communication device 1 transmits “DHCPDISCOVER”. At this point, an initialization process of setting a retry counter and a response waiting timer to a specified value is performed as well.

Upon transmission of the address assignment request, the communication device 1 starts up the response waiting timer and decrements the retry counter, to start a response waiting operation. The response waiting operation continues until the response waiting timer is timed out (Steps S12 and S13). In other words, the communication device 1 regularly checks whether the response waiting timer is timed out, and if the response waiting timer is not timed out (NO at Step S13), continues the response waiting operation. When the response waiting timer is timed out (YES at Step S13), the communication device 1 checks whether an IP address assignment response has been received (Step S14). When an IP address has been assigned (YES at Step S14), the communication device 1 checks whether the assigned IP address is usable (Step S17). The communication device 1 determines whether the IP address is usable based on the interface management table 12. Specifically, when the assigned IP address matches an IP address already assigned to another network interface (that is an IP address already registered in the interface management table 12) (when an address conflict occurs), or in the case of a NULL address or a local-link address, the communication device 1 determines that the IP address is unusable.

When the assigned IP address is usable (YES at Step S17), the communication device 1 determines to use the IP address by the network interface IF_t and ends the operation. At this point, the communication device 1 registers the assigned IP address in the interface management table 12 as an IP address used by the network interface IF_t. Other predetermined processes (various processes required for starting to use the assigned IP address) are also performed. In contrast, when the assigned IP address is unusable (NO at Step S17), the communication device 1 refers to the interface management table 12 to check whether there is a network interface IF_X having a lower priority than that of the network interface IF_t (Step S18).

When there is the network interface IF_X (YES at Step S18), the communication device 1 disconnects the network interface IF_X to release the IP address assigned thereto, and reserves a reconnection operation of the network interface IF_X (a reassignment operation of an IP address) (Step S21). Furthermore, at Step S21, the interface management table 12 is updated. For example, the IP address of the network interface IF_X registered in the interface management table 12 is changed to an unusable temporary address (a NULL address or the like). In this manner, by disconnecting the network interface IF_X having a low priority and then performing the IP-address assignment operation on the network interface IF_t again, the possibility of a usable IP address being assigned can be increased. When there are a plurality of network interfaces IF_X, the communication device 1 checks the priority of the address assignment protocol of each network interface IF_X (see FIG. 3), to disconnect the network interface IF_X having the lowest priority. Further, when there are a plurality of network interfaces IF_X having the lowest priority, the communication device 1 disconnects the network interface that was last assigned an IP address. A method of specifying the network interface that was last assigned an IP address is not particularly limited. For example, the time at which an IP address is assigned is registered in the interface management table 12, and the network interface that was last assigned an IP address is specified based on the information. If there is a network interface IF_X that has already been assigned the IP address that is the same as the IP address assigned to the network interface IF_t, the network interface IF_X can be disconnected preferentially. In this case, because the address conflict is resolved, the IP-address assignment operation with respect to the network interface IF_t does not need to be performed again. As a result, the processing time can be shortened and the processing load can be reduced.

After performing Step S21, the process returns to Step S11, and the IP-address assignment operation with respect to the network interface IF_t is continued. The reconnection operation of the network interface IF_X is performed after the IP-address assignment operation with respect to the network interface IF_t is finished. The reconnection operation of the network interface IF_X is performed in a similar manner to the IP-address assignment operation with respect to the network interface IF_t. In other words, an operation according to the flowchart shown in FIG. 4 is performed. When the address conflict is resolved by disconnecting the network interface IF_X, the reconnection operation of the network interface IF_X is immediately performed.

At Step S18, when it is determined that the network interface IF_X is not present (NO at Step S18), the communication device 1 checks whether there is a network interface IF_Y having the same priority as that of the network interface IF_t and having a low priority for the address assignment protocol to be used in the IP address assignment by checking the interface management table 12 (Steps S19 and S20).

When there is the network interface IF_Y (YES at Step 19, YES at Step S20), Step S21 described above is performed on the network interface IF_Y. At Step S20, a network interface having the lowest priority for the address assignment protocol is selected. When there are a plurality of network interfaces having the lowest priority, a network interface that was last assigned an IP address is selected similarly to the case at Step S18.

As explained above, the priority of the address assignment protocol is predetermined based on the requirement specifications of the communication system and the like. When the priority of a protocol having high possibility of avoiding an address conflict when the address conflict occurs, i.e., the priority of a protocol having the reassignment function of an IP address, is set low, even if an address conflict occurs, the possibility of avoiding the address conflict is high because of the reassignment function of an IP address, in the reconnection operation after being disconnected once (the reassignment operation of an IP address). Accordingly, it is possible to reduce the possibility of an unusable IP address being assigned.

In contrast, when the network interface IF_Y is not present (NO at Step 19, or NO at Step S20), the communication device 1 disconnects the network interface IF_t at Step S22 (releases the assigned IP address), to end the operation. At this point, the communication device 1 can notify the application of the fact that the network interface IF_t is disconnected and the reason for the disconnection at a predetermined timing by leaving address assignment information and reassignment information (information on an unusable IP address assigned to the network interface IF_t) in a log as the reason for the disconnection. The application can present information on the unusable IP address and the necessity of disconnecting another connection IF to a user and request the user to perform disconnection and reconnection operations on another network interface.

Furthermore, when it is determined that the IP address assignment response has not been received at Step S14 (NO at Step S14), the communication device 1 checks whether the retry counter is 0 (Step S15). When the retry counter is not 0 (NO at Step S15), the process returns to Step S11, and the IP-address assignment request is retransmitted. In this case, a process of setting the retry counter to a specified value is not performed.

In contrast, when the retry counter is 0 (YES at Step S15), the communication device 1 checks whether reassignment of an IP address has been performed (Step S16). “Reassignment of an IP address” here means an IP-address assignment operation to be performed again after Step S21 described above has been performed. In other words, when Step S21 has been performed once or more, it is determined that the reassignment has been performed. When the reassignment has been performed (YES at Step S16), the communication device 1 ends the IP-address assignment operation. In contrast, when the reassignment has not been performed (NO at Step S16), the process proceeds to Step S18, and the operation is continued.

The communication device 1 repeats the operation shown in FIG. 4 (the IP-address assignment operation with respect to the network interface IF_t) until a usable IP address is assigned to the network interface IF_t or the network interfaces IF_{—} X and IF_Y are not present, or until IP address assignment with respect to an IP-address assignment request is not performed in a state where reassignment of an IP address has been performed (until a determination result at Step S16 becomes YES). When the IP-address assignment operation with respect to the network interface IF_t is finished, the IP-address assignment operations with respect to the network interfaces IF_X and IF_Y disconnected by the operation are performed. The IP-address assignment operations with respect to the network interfaces IF_X and IF_Y are performed starting from the IP-address assignment operation with respect to the network interface that is disconnected first.

In this manner, in the present embodiment, the communication device manages the IP address assignment status with respect to each network interface, the priority of the network interfaces, the information on the address assignment protocol to be used in the IP address assignment (including the priority), and the like in a table format. When an IP address is assigned to a certain network interface (a first network interface), the communication device determines whether it is a usable IP address. When it is an unusable IP address, the communication device releases the IP address assigned to a network interface having a low priority (a second network interface), and then performs the IP-address assignment operation with respect to the first network interface again. Furthermore, after the IP-address assignment operation with respect to the first network interface is completed, the communication device performs the IP-address assignment operation with respect to the second network interface. Accordingly, even if an address assignment protocol that does not have the reassignment function is used, a communication device that can resolve an IP address conflict at the time of occurrence of the IP address conflict can be realized. Further, it is possible to realize a communication device that can be reassigned a usable IP address when an IP address that does not conflict with assigned IP addresses but is unusable is assigned. In the case of the address assignment protocol that does not have the reassignment function, if assignment of an IP address is requested under the same condition, the possibility of the same IP address being assigned is high. However, because assignment of the IP address is requested after another network interface is disconnected, it is possible to increase the possibility of an IP address that does not conflict with assigned IP addresses and is usable being assigned.

### INDUSTRIAL APPLICABILITY

As described above, the communication device according to the present invention is useful as a communication device that includes a plurality of network interfaces and is used by setting an IP address to each individual network interface.

### REFERENCE SIGNS LIST

1 communication device

2 address assignment device

11 address management unit

12 interface management table

13 protocol management table

14 communication control unit

15 network interface (NW-IF)

1-5. (canceled)

6. A communication device including a plurality of network interfaces to which an IP address is assigned, the communication device comprising:
an interface management table that stores therein a priority of giving the IP address to each of the network interfaces and an IP address assignment status with respect to each of the network interfaces; and
an address management unit that, when an IP address is assigned to a first network interface from an address assignment device and it is determined that the IP address has already been assigned to another network interface on a basis of the IP address assignment status, compares a priority of the another network interface with a priority of the first network interface, and, when the priority of the another network interface is lower than the priority of the first network interface, releases an IP address of the another network interface and gives the IP address to the first network interface.

7. The communication device according to claim 6, further comprising a protocol management table that manages a priority of an address assignment protocol to be used in IP address assignment, wherein
the interface management table further stores therein an address assignment protocol to be used in IP address assignment to each of the network interfaces, and
when an IP address is assigned to the first network interface from the address assignment device and it is determined that the IP address has already been assigned to another network interface on a basis of the IP address assignment status, the address management unit compares a priority of the another network interface with a priority of the first network interface, when the priority of the another network interface is same as the priority of the first network interface, the address management unit compares a priority of an address assignment protocol used in IP address assignment to the another network interface with a priority of an address assignment protocol used in IP address assignment to the first network interface, and, when the priority of the address assignment protocol used in IP address assignment to the another network interface is lower than the priority of the address assignment protocol used in IP address assignment to the first network interface, the address management unit releases an IP address of the another network interface and gives the IP address to the first network interface.

8. The communication device according to claim 7, wherein a priority of an address assignment protocol that has an IP-address reassignment function is set to be lower than a priority of an address assignment protocol that does not have an IP-address reassignment function.

9. The communication device according to claim 7, wherein when there is another interface that has already been assigned an IP address that is same as that assigned to the first network interface and the assigned IP address is not capable of being released, a user is notified that an unusable IP address is assigned to the first network interface.

10. A communication system comprising:
the communication device according to claim 6; and
an address assignment device that assigns an IP address managed by the address assignment device itself in response to a request from the communication device.
